(19) United States
(12) Patent Application Publication
(10) Pub. No.: US 2012/0031516 A1
(43) Pub. Date: Feb. 9, 2012

(54) Axle Sleeve Manufacturing Process

(75) Inventors: Richard B. Yori, III, Stow, OH (US); Paul Lioi, Canton, OH (US)

(73) Assignee: National Machine Company

(21) Appl. No.: 13/163,956

(22) Filed: Jun. 20, 2011

Related U.S. Application Data
(60) Provisional application No. 61/356,190, filed on Jun. 18, 2010.

(51) Int. Cl. F16L 55/00; B23P 11/00; C22F 1/00; B23B 3/00; B60B 37/00; C21D 9/08

(52) U.S. Cl. 138/103; 301/122; 188/218 R; 148/559; 82/1.11; 29/428

(57) ABSTRACT

A system and method for the manufacture of aircraft landing gear axle equipment is provided of two primary steps: hot pierce and tube solid billet stock; and flow form process. The hot pierce and tube process converts a standard solid round billet by heating it well beyond its annealing temperature. The billet is then pierced with a lance and hot rolled into a seamless tube. The tube is then precision flow formed as an incremental metal forming technique in which a tube of metal is formed over a mandrel by a multiple rollers using tremendous pressure. The rollers deform the work piece, forcing it against the mandrel, simultaneously lengthening the part axially and radially thinning the cross-sectional wall of the workpiece.

### RELATED APPLICATIONS

The present application claims the benefit of U.S. Provisional Application 61/356,190, filed on Jun. 18, 2010 and incorporated by reference as if fully rewritten herein.

### BACKGROUND OF THE INVENTION

1. Technical Field of the Invention

The present invention relates generally to the manufacture of aircraft landing gear axle equipment and, in particular, to the application of room temperature rotary metal forming technology in the production of aircraft landing gear axle equipment.

2. Description of the Background Art

Axle sleeves, wheel sleeves and brake sleeves are commonly utilized in aircraft landing and brake systems. These sleeves protect the aircraft axle by providing protection from foreign object damage during flight operations. By way of example, as shown in FIG. 1 and FIG. 2, the axle sleeve on a Airbus™ A330 is shown according to the PRIOR ART, forming a thin, protective, consumable member mounted between the axle and wheel bearings to allow for replacement in the change of damage occurring. Given the weight sensitivity of these applications, these cylindrical sleeves typically have a difficult combination of thin wall and precision tolerances.

Traditionally, these sleeves have been manufactured according to a process generally outlined in FIG. 3 in which solid metal bar stock 10 is rough machined 20 to form a near net shaped sleeve through conventional rough machining operations. Materials that are currently used to make such sleeves are steel alloys, such as 15-5 and 17-4, in that these materials have sufficient properties of strength, weight, corrosion or fatigue resistance, and the like. However, as with any component that is for use with aircraft, in the situation where other physical performance and characteristics are equally achieved, a significant premium is placed on reduced weight, and as such preferred material for such an application would be aluminum alloys and titanium alloys such as Ti-6AL4V. However, such is not currently economically viable, as will become apparent below.

The prior art steel alloys are formed into parts that are near net shaped 20, and then heat treated 40 prior to final machining 50 and processing 60. However, the rough machining process 20 creates a large amount of wasted material 30 as the interior of the hollow formed shape is removed and not used for the final product. Since the use of titanium allows has a relatively high cost premium, the creation of this large amount of waste by using prior art methods makes this selection uneconomical for such a consumable component. It has been found that in the manufacturing of similar products for use on landing gear systems, a primary source of waste was the fact that the process manufactured tubes from bar stock, resulting in a significant amount of scrap material that had little value. The processing time, machine time, and overall logistics and handling further add to the overall waste and, subsequently, cost of the completed component.

The flow forming process (also known as floturning) is a method of rotary metal forming which produces hollow formed parts, both round in cross section, as well as straight-sided cones, contoured cones or cylindrical shaped parts. In a sense, the flow forming utilizes a three-dimensional variation of the basic rolling process that is used in a steel mill to produce flat sheet, starting with a thick slab.

Improvements to this traditional axle sleeve manufacturing process have been herein designed and developed by converting the raw material bar stock to a seamless tube through processes similar to and known by seamless tube manufactures. Specifically, by implementing a rotary pierce process in which the raw material bar stock is pierced, elongated, sized, and sized through rotary processes, it was found that final product yield doubled from initial raw material (i.e., cut raw material costs nearly in half). While this was a significant improvement, continued improvements in yield would provide much greater overall benefits, such as to allow adaptation to lighter weight, yet more expensive materials (such as titanium).

Consequently, the ability to implement a process to produce axle sleeves, wheel sleeves and brake sleeves through the incorporation of flow forming techniques will yield an additional 3:1 improvement in material utilization from recent manufacturing improvements, as well as a total material utilization improvement of 6:1 (600%) when compared to the baseline bar stock manufacturing process.

### SUMMARY OF THE INVENTION

It is therefore an object of the present invention to provide improved axle sleeves, wheel sleeves and brake sleeves for aircraft.

It is a feature of the present invention to provide such aircraft products through the incorporation of flow forming techniques.

The methods of this invention comprise flowforming metals that have not heretofore been used to fabricate axle sleeves, wheel sleeves and brake sleeves designed to protect the aircraft axle from foreign object damage during repeated landings. The metals may include nickel-based superalloys, cobalt-based superalloys, iron-based superalloys, high strength steel, titanium and titanium alloys, tantalum and tantalum alloys, chromium and chromium alloys, zirconium and zirconium alloys, niobium and niobium alloys, and two or more of these metals that have been integrally bonded together. These metals are initially fabricated as preforms that are suitable for flowforming into the desired axle sleeves, wheel sleeves and brake sleeves or designated tubular device.

Further, a preferred embodiment of the present invention has entails the application of such flowforming manufacturing technologies in an innovative manner to manufacture an existing product (axle sleeves, wheel sleeves or brake sleeves) in a cost effective manner. It is anticipated that additional future applications, in light of the current teachings, can be applied to production of other products, such as rocket motors, aluminum wheels, clutch housings (internal splines) and the like.

Briefly described according to one embodiment of the present invention, the improved manufacture of aircraft landing gear axle equipment is provided through a process that incorporates the application of room temperature rotary metal forming technology and flow forming of near net shaped rough components. Flow forming is a process where a tubular preform is cold worked over a mandrel to produce a near net shape part. The flow formed blanks exhibit tight dimensional tolerances and improved mechanical properties from cold working.

The axle sleeves, wheel sleeves and brake sleeves of this invention may also include two or more metals that have been integrally bonded together into a preform where one of the metals is a nickel-based superalloy, a cobalt-based superalloy, an iron-based superalloy, a high strength steel, titanium or a titanium alloy, tantalum or a tantalum alloy, chromium or a chromium alloy, zirconium or a zirconium alloy, niobium or a niobium alloy, and at least one other metal that is not from this aforesaid group. In these instances, the at least one other metal can be a steel that has heretofore conventionally been used to form axle sleeves, wheel sleeves and brake sleeves or similar tubular devices. These fabricated preforms are flowformed in this invention into axle sleeves, wheel sleeves and brake sleeves or similar tubular devices. To do so, bar stock is hot-formed in a tube mill through a process known as ‘hot pierce and tube’. This results in a hollow, seamless tube. This tube is then subjected to an annealing operation and then a rough machining operation. This machined pre-form may then subjected to a room temperature forging process that forms the pre-form into a cylindrical tube or other shape that has a specific internal and external geometry.

It is a feature of the present invention to provide such aircraft products through the incorporation of flow forming techniques that will yield an additional 3:1 improvement in material utilization from recent manufacturing improvements. It is a further feature of the present invention that a total material utilization improvement of 6:1 (600%) can be achieved, as compared to the baseline bar stock manufacturing process.

While there are additional costs associated with the additional processing, the material savings benefits far outweigh these additional process costs. With the continued escalation of metal prices, the use of such a process to reduce the amount of wasted raw material will achieve ever increasing savings in the manufacturing these products. By combining the hot pierce and tube process with the forging process, it is possible to reduce the raw material required to manufacture an axle sleeve by approximately 600%.

Additional savings accrue from the near net shape of the flow formed blank. This enables the drastic reduction, or even the total elimination of the rough machining process altogether. Traditional manufacturing of these products requires a rough machining operation prior to final thermal heat treatment. Without this rough machining process, the sleeve would retain significant residual stresses from heat treatment and would not be sufficiently stable to meet the final dimensional tolerances. However, according to the present invention, the shape of the formed part after forging results is sufficiently similar to the final geometry, that the formed part can be directly heat treated, eliminating the rough machining process altogether.

Another advantage of the present invention is the creation of improved mechanical properties within the finished component. The forging process improves the direction of the material grain and improves the mechanical properties of the sleeve as compared to manufacturing from bar stock.

Yet another advantage of the present invention is the ability to adapt the flow forming process for use with other steel alloys, such as 15-5 and 17-4 currently being used, to other, more expensive and lighter weight materials such as aluminum alloys and titanium alloys such as Ti-6AL4V.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a partial cross sectional view of an axle sleeve for an Airbus A320, shown mounted between the axle and wheel bearings, according to the PRIOR ART;

FIG. 2 is a photograph thereof, shown visible during aircraft wheel replacement, according to the PRIOR ART;

FIG. 3 is a process flow diagram for the manufacture of a seamless tube blank according to the PRIOR ART prior to the flow forming forging process;

FIG. 4 shows a rough comparison between metal spinning a conical part and flow forming a conical part;

FIG. 5 shows the comparison between metal spinning a cylindrical part as compared to flow forming a cylindrical part;

FIG. 6 is a perspective view of a hot pierced tube blank preformed by the process of FIG. 10;

FIG. 7 shows an illustrative flowforming device according to embodiments of the present invention;

FIG. 8 shows a side-view of a workpiece undergoing a forward flowforming process according to embodiments of the present invention; and

FIG. 9 shows a side-view of a workpiece undergoing a reverse flowforming process according to embodiments of the present invention; and

FIG. 10 is a process overview of the flow forming forging process according to the preferred embodiment of the present invention;

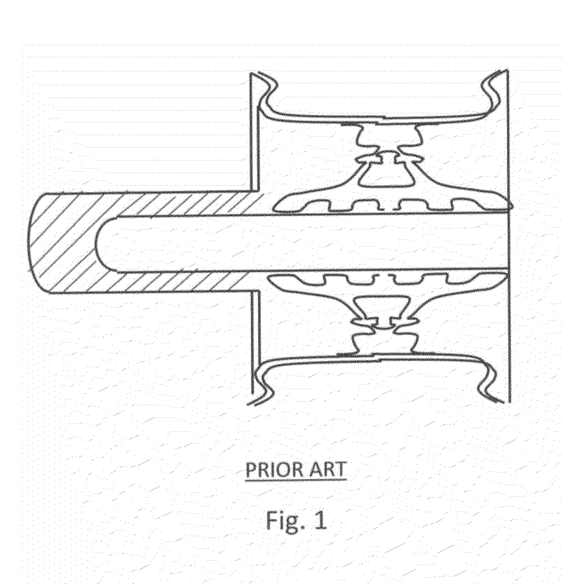

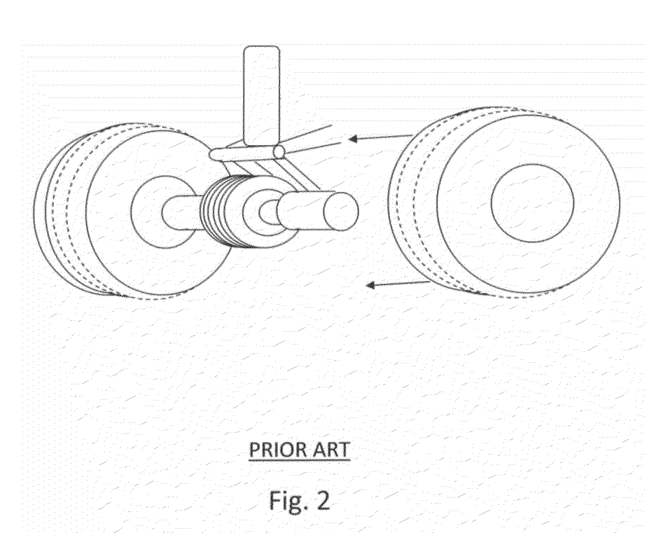

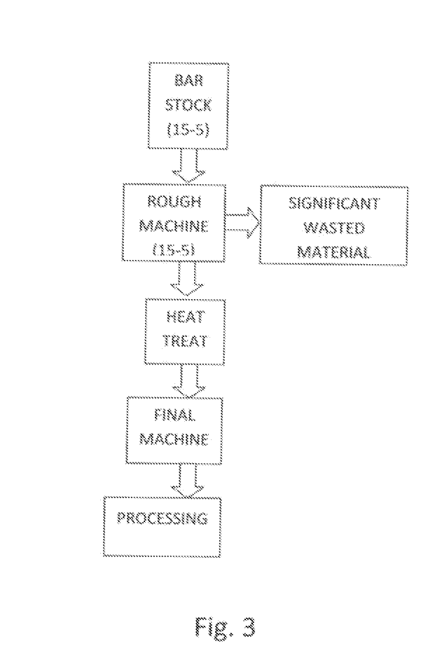

### DESCRIPTION OF THE PREFERRED EMBODIMENTS

A description of preferred embodiments of the invention follows. While this invention has been particularly shown and described with references to preferred embodiments thereof, it will be understood by those skilled in the art that various changes in form and details may be made therein without departing from the scope of the invention encompassed by the appended claims.

Flowforming is an advanced cold-forming process for the manufacture of hollow components. Flowforming allows for the production of dimensionally precise and rotationally symmetrical components and is typically performed by compressing the outside diameter of a cylindrical component or preform over an inner rotating mandrel using a combination of axial and radial forces from one or more rollers. The metal is compressed and plasticized above its yield strength and made to flow in the axial direction onto a mandrel. The workpiece being formed, the rollers, and/or the mandrel can rotate. Two examples of flowforming methods are forward flowforming and reverse flowforming. Generally, forward flowforming is useful for forming tubes or components having at least one closed or semi-closed end (e.g., a closed cylinder). Reverse flowforming is generally useful for forming tubes or components that have two open ends (e.g., a tube having two open ends).

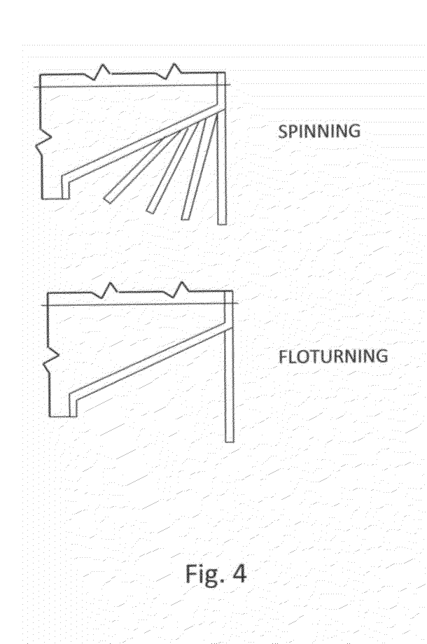

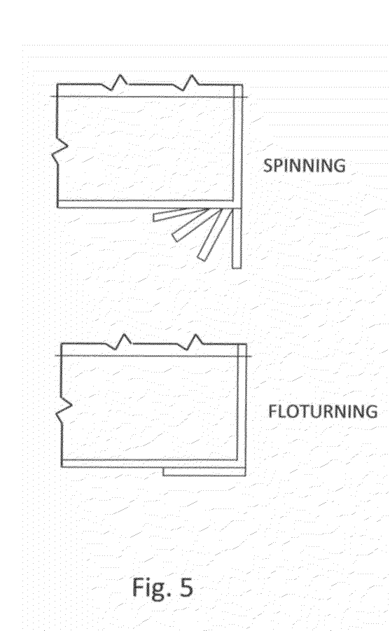

Flow forming is very similar to conventional metal spinning. It must be understood that there is a very basic difference between metal spinning and flow forming. Conventional metal spinning utilizes a relatively thin piece of material and produces the shape of the finished part from the diameter of the starting blank. Flow forming produces a finished shape by working from the thickness of the starting blank, creating a part considerably thinner than the starting blank. As shown in FIG. 4, a rough comparison between metal spinning a conical part and flow forming a conical part is shown. In conjunction with FIG. 5, the comparison between metal spinning a cylindrical part as compared to flow forming a cylindrical part is shown.

The flow forming process must not be confused with swaging or upsetting operations, as material is not reduced in diameter as in swaging, or gathered to increase thickness as in upsetting.

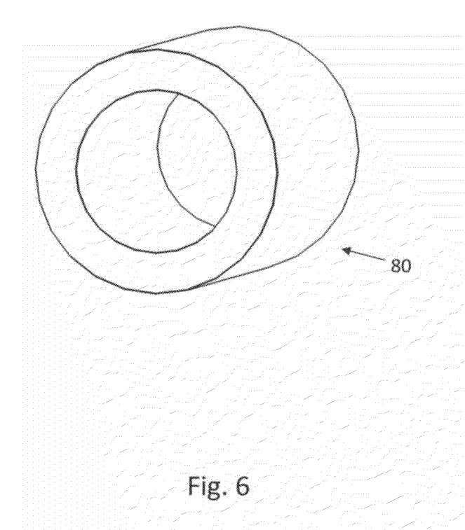

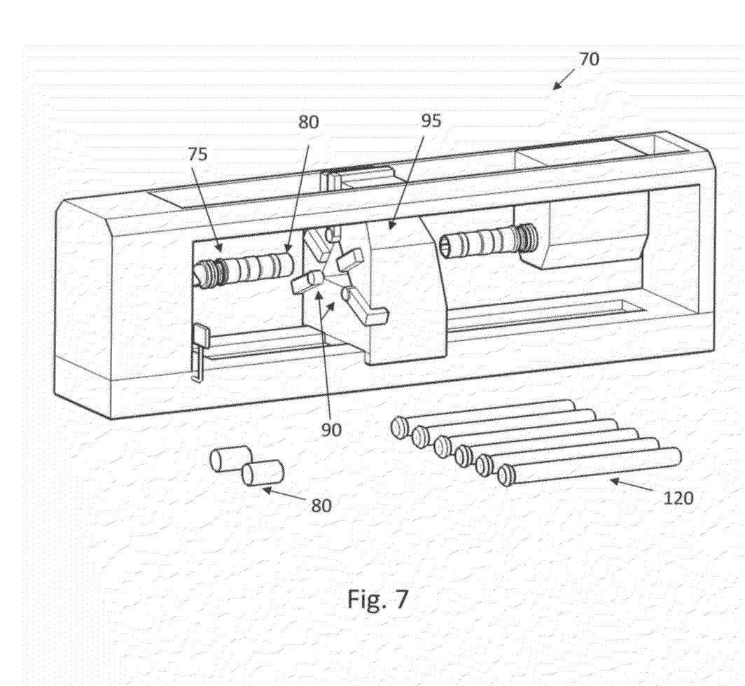

According to the present invention, precision flow forming for axle sleeves is then conducted as is an incremental metal forming technique utilizing a CNC flow forming machine as typified in FIG. 5, which schematically illustrates a flowforming device 70 according to some embodiments of the present invention. In this case, the flowforming device 70 is configured for forward flowforming, as will be described in greater detail in conjunction with FIG. 6. The flowforming device 70 includes a mandrel 75 for holding a cylindrical workpiece 80, a tailstock 85 that secures the workpiece 80 to the mandrel 75, two or more rollers 90 for applying force to the outer surface of the workpiece 80, and a movable carriage 95 coupled to the rollers 90. As shown in FIG. 5, the rollers 90 may be angularly equidistant from each other relative to the center axis of the workpiece 80. The rollers 90 may be hydraulically-driven and CNC-controlled. The workpiece 80 is thereby formed over a mandrel 75 by the multiple rollers 90 using tremendous pressure. The rollers 90 deform the work piece 80, forcing it against the mandrel 75, simultaneously lengthening the part axially and radially thinning the cross-sectional wall of the workpiece.

To produce the tubes 100 for axle sleeves, wheel sleeves and brake sleeves of this invention, the workpiece 80 is created as a metal preform fabricated to be the starting material for the subsequent flow forming operations. The metal preform, as shown best in conjunction with FIG. 6, is the workpiece 80 from which the axle sleeves, wheel sleeves and brake sleeves or similar tubular devices 100 are flow formed. Typically, the metal preform is fabricated into the workpiece shape of a hollow cylinder which as one or two open ends.

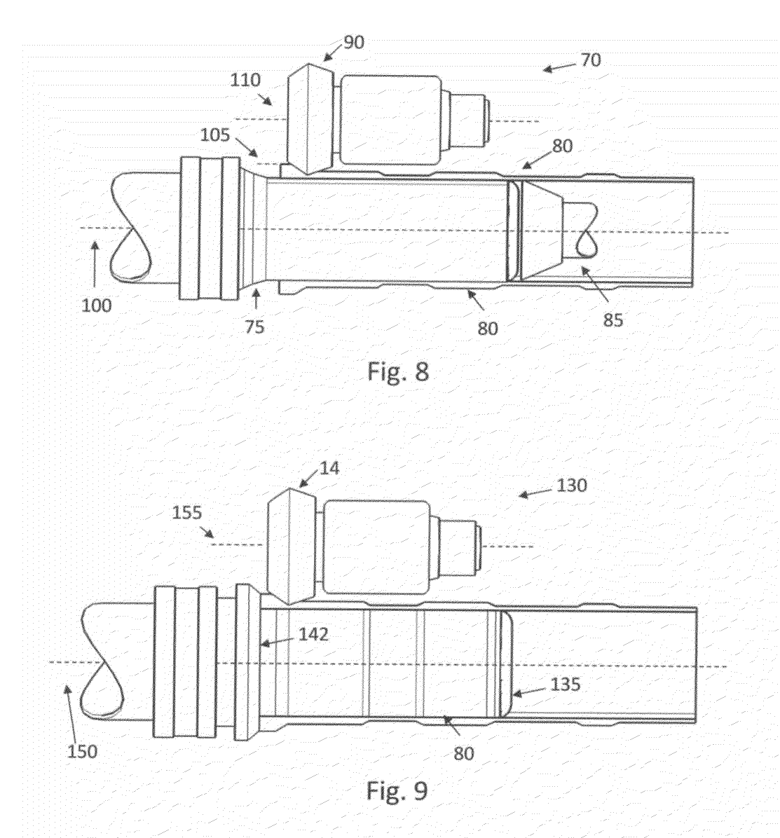

FIG. 8 illustrates a side-view of a workpiece 80 undergoing a forward flowforming process with an exemplary forward flowforming device 70. Device 70 includes mandrel 75, tailstock 85, and roller 90. In operation, the preform 80 is placed over mandrel 75. The mandrel 75 is rotated about a major axis 100. The tailstock 85 applies an amount of force or pressure to the preform 80 to cause the preform 80 to rotate with mandrel 75. As the mandrel 75 and preform 80 rotate together, the roller 90 is moved into a position so that it contacts the outer surface of the preform 80 at a desired point along the length of the perform 80. Roller 90 compresses the outer surface of preform 80 with enough force so that the metal of the preform 80 is plasticized and caused to flow in direction 105, generally parallel to axis 100.

The roller 90 can be positioned at any desired distance from the outer diameter of mandrel 75 or the inner wall of preform 80, thereby compressing the walls of the preform 80 to a desired thickness at the point of compression.

While the mandrel 75 and preform 80 continue to rotate, roller 90 is moved down the length of preform 80, generally in direction 110, thereby compressing additional portions of the length of preform 80 to a desired thickness. As it moves down the length of preform 80, the roller 90 can be positioned at different distances relative to mandrel 75 or it can be kept at the same distance relative to mandrel 75. As the rollers 90, the perform 80 is deformed into a metal or metal alloy tube 120 having walls with a desired thickness or thicknesses.

This operation is termed “forward flowforming” because the deformed material flows in the same direction that the rollers are moving.

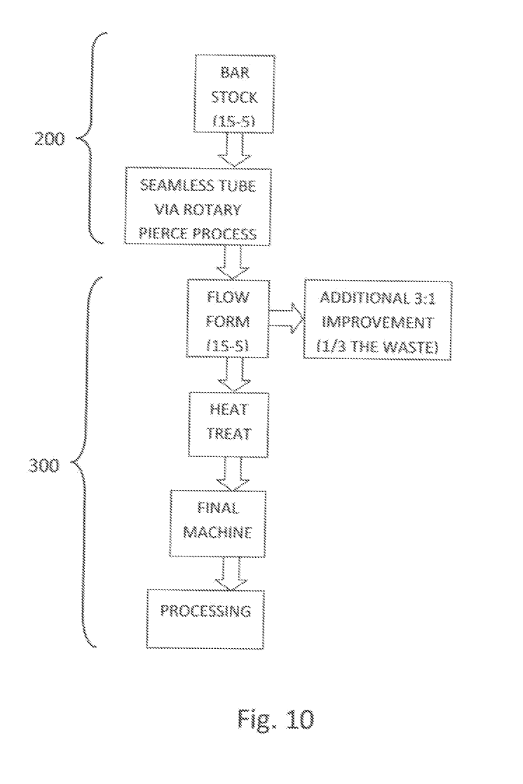

Referring now to FIG. 9, a schematic diagram is provided showing a side-view of exemplary reverse flowforming device 130. Device 130 includes a mandrel 135, a drive ring 140, and roller 145. In some embodiments, the flowforming device includes more than one roller (e.g., two or three rollers), usually angularly equidistant from each other relative to the center axis of the workpiece. The preform 80 is placed over mandrel 135 and pushed against drive ring 140. The mandrel 135 rotates about its major axis 150. As the mandrel 135 rotates, the roller(s) 145 are moved into a position so that it contacts the outer surface of preform 80 at a desired point along the length of the preform. In a similar fashion, the roller 145 presses the preform 80 against drive ring 140, thereby causing the preform 80 to rotate with mandrel 135. The drive ring 140 may have a series of protruding splines 142 on its face or other means for securing the preform 80 so that it will rotate with mandrel 35. In this manner the roller(s) 145 compress the outer surface of preform 80 with enough force so that the metal of the preform is plasticized and caused to flow under roller 145 6 and in direction 155, generally parallel to axis 150.

The roller 145 can be positioned at any desired distance from the outer diameter of mandrel 135 or the inner wall of perform 80, thereby compressing the walls of the preform to any desired thickness at the point of compression.

While the mandrel 135 and preform 80 continue to rotate, roller 145 is moved down the length of preform 80, generally in direction 155, thereby compressing additional portions of the length of the preform 80 to a desired thickness or thicknesses. As it moves down the length of the preform 80, the roller 145 can be positioned at different distances relative to mandrel 135 or it can be kept at the same distance relative to mandrel 135. As the roller(s) 145 move(s) down the length of a perform 80, the roller(s) deform(s) the preform into a metal or metalalloy tube having walls with any desired thickness.

This operation is termed “reverse flowforming” because the deformed material flows in the direction opposite to the direction that the rollers are moving.

In either forward flowforming or reverse flowforming, the preform may be subjected to one or more (e.g., at least two, three, four, five, or more than five) flowforming passes, with each flowforming pass compressing the walls of the preform or some portion of the walls of the preform into a desired shape or desired thickness. This process improves the grain structure and the physical characteristics of the metal to be advantageous to aviation brake and wheel sleeves.

In production of a prototype, the process describe above was implement as shown in conjunction with FIG. 10 to flow formed of an Inox 17-4 PH tube from their supplier. The process consists of two primary steps: hot pierce and tube solid billet stock 200; and a flow form process 300.

The hot pierce and tube process 200 can be used for other for different mechanical applications. To use the process 200 on a commercial basis for axle sleeves, the hot pierce and tube process converts a standard solid round billet 210 heating it well beyond its annealing temperature. The billet 210 is then pierced with a lance and hot rolled into a seamless tube 220. The finished product at this point is nearly 2.5 times its original length. The tube can be solution annealed and heat treated to AMS 5643 specifications.

While the use of steel alloys, such as 15-5 and 17-4, and aluminum alloys and titanium alloys such as Ti-6AL4V are considered for use in the preferred embodiment of the present application for use to form axle sleeves, wheel sleeves and brake sleeves or similar tubular devices, the fabrication of the metal preform 80 may also be achieved by one or more processes known in the material processing art in order to expand the teachings made herein and for the manufacture of alternate designs of axle sleeves, wheel sleeves and brake sleeves, similar tubular devices or even other products altogether. These processes may include extrusion, casting, rolling, gun drilling, machining, hot isostatic pressing (also known as “HIPing”), rotary-piercing, rotary forging, and combinations thereof.

In some instances, the fabrication of the metal preform 80 may include extrusion of at least a portion of the metal or metals that comprise the perform 80. In further refinements, the fabrication of the metal perform 80 may include extrusion of at least a portion of the metal or metals that comprise the preform where the metal or metals are in the form of a bar, a billet, a consolidated metal powder (e.g., a metal powder that has been sintered and HIPed), and/or a metal casting. In other instances, the fabrication of the metal preform may include machining a cast billet, a cast bar, a cast hollow, a rolled bar, or a rolled billet of the metal or metals.

The metals that form the perform 80, and subsequent tubes 120 of this invention may further include nickel-based superalloys, cobalt-based superalloys, iron-based superalloys, high strength steel, titanium, and titanium alloys. These metals have the property of being strong (able to maintain their shape when subject to shock) often at elevated temperatures. These metals also do not corrode easily, either due to oxidation or to the corrosive environments. These metals can withstand heat generated by repetitive braking without noticeable loss of strength. They are also resistant to increased corrosion that can occur at the elevated temperatures caused by such friction. These properties allow the sleeves and tubular devices to be made with thinner walls than previously feasible. These properties of these metals also allow inner liners for axle sleeves, wheel sleeves and brake sleeves and similar tubular devices to now be made. The liners can then be surrounded by other metals, or with composite filament wraps, or resins for structural or cosmetic purposes.

There are numerous specific metals that can be also be used in the methods and articles of manufacture of this invention. Superalloys, in particular, can be used. Superalloys are high performance materials designed to provide high mechanical strength and resistance to surface degradation at high temperatures of 1200° F. (650° C.) and above. These alloys combine high tensile, creep-rupture, and fatigue strength; good ductility, and toughness, with excellent resistance to oxidation and hot corrosion. Superalloys with the same composition are often made by different mills, who attach their specific tradename to their product. For example, Alloy 718 is referred to as Inconel 718, Pyromet 718, or Nickelvac 718, depending on the mill that produces this alloy. Because different mills produce superalloys, these metals are sometimes organized by the industry into families depending on their tradenames (i.e., their manufacturer). The families include the Inconel, Hastelloy, Stellite, Nickelvac, and Pyromet superalloys. Examples of specific superalloys that can be used in the present invention are Alloy X-750B, Alloy X-750A, Alloy 80A, Alloy A-286, Alloy 31V, Alloy 625, Alloy 706, Alloy 725, Alloy 751, Alloy 901, Alloy 706, Alloy 41, Alloy 718, Alloy 720, Alloy CTX-909, Alloy NCF 3015, Alloy Thermospan, Alloy Waspaloy, Alloy Waspaloy A, Alloy Waspaloy B, Alloy Haynes 228, Alloy B3, Alloy C-276, Alloy 601, Alloy Rene 220, and Alloy PWA 1472.

High strength steels can also be used in the methods and articles of manufacture of this invention. High mechanical strength and retention of this strength at elevated temperatures are properties that are sought for these steels in this invention. Specific examples of such steels are Maraging Steel C-250, Maraging Steel C-300, and Maraging Steel T-250.

Another group of metals that can be used in the methods and articles of manufacture of this invention are titanium and titanium alloys. These titanium metals occur in alpha (α), alpha-beta (α-β), or beta (β) crystallographic forms. These metals are highly corrosion resistant, lightweight and also possess the desired properties of tensile strength, toughness, and resistance to fatigue, even at the high temperatures that are created during the braking of an aircraft landing. Examples of these metals are Titanium 6Al-4V, Titanium 6Al-4V ELI, Titanium 3Al-2.5V, Titanium 6Al-2Sn-4Zr-2Mo, Titanium 6Al-2Sn-4Zr-6Mo, and Titanium 4Al-2.5V.

The present invention may also includes tubes for axle sleeves, wheel sleeves and brake sleeves and flowforming methods of fabricating such tubes where the starting preform is made of two or more metals that have been integrally bonded together before the flowforming step is performed. The two or more metals are integrally bonded together by any suitable process, such as hot isostatic pressing (HIPing), diffusion bonding, and shrink fitting. One of these metals is a metal described in the foregoing embodiments of the invention; i.e., a nickel-based superalloy, a cobalt-based superalloy, an iron-based superalloy, a high strength steel, titanium, a titanium alloy, tantalum, a tantalum alloy, chromium, a chromium alloy, zirconium, a zirconium alloy, niobium, or a niobium alloy. At least one metal of these preforms (the other metal if only two metals are used) is not a metal from this group of metals. For example, the second metal can be a steel that is not an iron-based superalloy or a high strength steel. A steel that is used in presently conventional axle sleeves, wheel sleeves and brake sleeves or similar tubular devices or similar tubular devices can be the second metal.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

Having thus described the invention what is claimed as new and desired to be secured by Letters Patent is as follows:

1. A method for the manufacture of aircraft landing gear axle equipment comprising the application of room temperature rotary metal forming technology in the production of aircraft axle sleeves, wheel sleeves and brake sleeves.

2. The method of claim 1, wherein a total material utilization improvement of 6:1 (600%) is achieved when compared to a baseline bar stock manufacturing process.

3. The method for the manufacture of aircraft landing gear axle sleeves, wheel sleeves and brake sleeves of claim 1, further comprising:
hot pierce and tube solid billet stock; and
flow forming said tube.

4. The method of claim 3, wherein said hot pierce and tube process converts a standard solid round billet by heating beyond its annealing temperature.

5. The method of claim 4, wherein said billet is then pierced with a lance and hot rolled into a seamless tube.

6. The method of claim 5, wherein said tube is solution annealed and heat treated to AMS 5643 specifications.

7. The method of claim 3, wherein said precision flow forming is then conducted as is an incremental metal forming technique in which a tube of metal is formed over a mandrel by a multiple rollers using tremendous pressure, wherein as the rollers deform the work piece, forcing it against the mandrel, the workpiece is simultaneously lengthening the part axially and radially thinning the cross-sectional wall of the workpiece.

8. A method of producing an improved axle sleeve, wheel sleeves or brake sleeves for aircraft, the method comprising:
forming a tubular perform workpiece from a billet through piercing, lancing and hot rolling a billet into a seamless tube; and
subjecting the workpiece to a wall reduction of at least about a 20% at a temperature below a recrystallization temperature of the workpiece using a metal forming process, the metal forming process comprising radial forging, rotary swaging, pilgering, flowforming, or a combination thereof.

9. The method of claim 8, wherein the temperature is around room temperature.

10. The method of claim 10, further comprising annealing the workpiece after subjecting the workpiece to the wall reduction.

11. The method of claim 8, wherein the metal forming process is flowforming, and the flowforming includes at least two flowforming passes.

12. The method of claim 11, wherein the wall reduction is at least about 30%.

13. The method of claim 11, wherein the wall reduction is at least about 50%.

14. A tubular component produced according to the method of claim 8.

15. The tubular component of claim 14, wherein said component is manufactured from a material selected from the group consisting of: type 15-5 alloy steel; type 17-4 alloy steel; aluminum alloys; and titanium alloys.

16. The tubular component of claim 14, wherein said component is manufactured of type Ti-6AL4V titanium alloy.

17. The method of claim 11, wherein the workpiece is flowformed nearly 2.5 times its original length.

18. The method of claim 13, further comprising annealing and heat treating said workpiece to AMS 5643 specifications.

19. A near net shaped tubular product for aircraft selected from the group consisting of: axle sleeves; wheel sleeves; and brake sleeves; and further comprising:
a configured, generally tubular sidewall flowformed from a seamless tube to at least 2 times its original length;
wherein said tubular sidewall is annealed and heat treated to comform to AMS 5643 specifications.
